(19) United States
(12) Patent Application Publication
(10) Pub. No.: US 2025/0115325 A1
(43) Pub. Date: Apr. 10, 2025

(54) FRONT SUSPENSION SYSTEM AND METHOD FOR THREE WHEELED VEHICLE

(71) Applicant: TUGA-GLOBAL, INC., Grand Haven, MI (US)

(72) Inventor: Samuel Alves Gomez, Legutiano (ES)

(21) Appl. No.: 18/906,897

(22) Filed: Oct. 4, 2024

Related U.S. Application Data
(60) Provisional application No. 63/587,847, filed on Oct. 4, 2023.

(51) Int. Cl. B62K 21/00; B62K 5/00; B62K 5/027; B62K 25/00; B62K 25/04

(52) U.S. Cl. CPC B62K 21/00; B62K 5/027; B62K 25/005; B62K 25/04; B62K 2005/001

(57) ABSTRACT

The present technology discloses a front suspension system for a three-wheeled vehicle, comprising a frame, a front wheel with a hub, a steering knuckle on the wheel hub, a lower control arm connecting the frame to the wheel hub, a steering arm attached to the steering knuckle, and a steering linkage linked to the steering arm. This front suspension system allows the three-wheeled vehicle to smoothly transition between an upright posture and a turning posture, where the front wheel leans in the direction of a turn while the frame maintains its upright position. The innovative design enhances stability and maneuverability during turns, providing a safer and more comfortable riding experience for users.

### CROSS-REFERENCE TO RELATED APPLICATIONS

This application claims the benefit of U.S. Provisional Application No. 63/587,847, filed on Oct. 4, 2023. The entire disclosure of the above application are incorporated herein by reference.

### FIELD

The disclosure relates generally to a motorized vehicle and, more specifically, a three wheeled motorized vehicle.

### INTRODUCTION

The statements in this section merely provide background information related to the present disclosure and may not constitute prior art.

Turning a two-wheeled motorcycle typically involves leaning the entire vehicle in the direction of the desired turn. This includes leaning the front and rear wheels, frame, power plant (engine or electric motor), and handlebars in the direction of the turn. This leaning technique is important for maintaining balance and improving the contact between the wheels and the road surface during turns.

Three-wheeled vehicles, also known as tricycles, present unique challenges when it comes to turning. These vehicles can have either a single front wheel with two rear wheels, or two front wheels with a single rear wheel. Regardless of the wheel configuration, three-wheeled vehicles often attempt to mimic the turning mechanics of two-wheeled motorcycles by leaning various elements of the vehicle during turns. In three-wheeled vehicle designs, turning is accomplished by leaning components such as the front wheel, frame, power plant, and gas tank or batteries relative to the level surface. This approach aims to improve handling and stability during turns by adjusting the center of gravity of the vehicle and increasing tire contact with the road surface.

However, the leaning method employed in three-wheeled vehicles can result in noticeable handling deficiencies. These issues arise from the fundamental differences in geometry and weight distribution between two-wheeled motorcycles and three-wheeled vehicles. The additional wheel in a tricycle alters the dynamics of the vehicle, making it challenging to achieve the same level of stability and control during turns as a two-wheeled motorcycle.

There is a continuing need for improved turning systems and methods for three-wheeled vehicles. Desirably, such improvements would address the handling deficiencies associated with conventional leaning techniques while maintaining stability and enhancing the overall riding experience.

SUMMARY

In concordance with the instant disclosure, improved turning systems and methods for three-wheeled vehicles, has been surprisingly discovered. The present technology includes articles of manufacture, systems, and processes that relate to a front suspension system and method for turning a three-wheeled vehicle.

In one embodiment, A front suspension system for a three-wheeled vehicle can comprise a frame and a front wheel with a hub. The system can include a steering knuckle disposed on the wheel hub of the front wheel. A lower control arm can have a first end disposed on the frame and a second end disposed on the wheel hub. The system can also include a steering arm affixed to the steering knuckle and a steering linkage connected to the steering arm. The front suspension system can be configured to enable the three-wheeled vehicle to transition between an upright posture and a turning posture. In the turning posture, the front wheel can lean in the direction of the turn while the frame remains substantially upright. This suspension system can allow for precise control over the orientation of the front wheel during turns, improving the overall handling behavior of the vehicle. The system can be designed to lean only the front wheel while maintaining the frame and rear wheel(s) in an upright posture during turning maneuvers.

In an additional embodiment, A front suspension system for a three-wheeled vehicle can include a frame and a front wheel with a hub. The system can include a hook-shaped steering knuckle disposed on the wheel hub of the front wheel. This steering knuckle can comprise a top portion that extends upward and over the front wheel, and a lower portion disposed substantially parallel to the front wheel. An L-shaped lower control arm can have a first end disposed on the frame and a second end disposed on the wheel hub. This lower control arm can be disposed on only one side of the front wheel. A connection element can be positioned between the second end of the lower control arm and the steering knuckle. This connection element can be configured to be laterally movable and can include a bearing or joint to facilitate movement between the lower control arm and the steering knuckle. The system can include a dampening system in communication with the lower control arm. This dampening system can include a dampening element disposed between the lower control arm and the frame. A steering arm can be affixed to the steering knuckle. This steering arm can have a top side and a bottom side, with the bottom side of the steering arm affixed to the steering knuckle. An upper control arm can be connected to the frame at a proximal end. The steering arm can include a projection at a distal end that is received by the upper control arm.

A steering linkage can be connected to the steering arm. This steering linkage can include a lower steering link with an extension that is affixed to the steering arm. The lower steering link can be hingedly attached to the extension of the steering arm. An upper steering link can be connected to the lower steering link via a bearing that allows for multiaxial rotation of the upper link. The system can also include a C-shaped steering fork in communication with the steering linkage. This steering fork can receive an end of the upper link at an open end of the steering fork. The front suspension system can be configured to enable the three-wheeled vehicle to transition between an upright posture and a turning posture. In the turning posture, the front wheel can lean in the direction of the turn while the frame remains substantially upright.

Further objectives and areas of applicability will become apparent from the description provided herein. It should be understood that the description and specific examples are intended for purposes of illustration only and are not intended to limit the scope of the present disclosure.

### DRAWINGS

The above, as well as other advantages of the present disclosure, will become readily apparent to those skilled in the art from the following detailed description, particularly when considered in the light of the drawings described hereafter.

FIG. 1 is a side perspective view of a front suspension system in accordance with one embodiment of the present disclosure;

FIG. 2 is a side view of the front suspension system of FIG. 1;

FIG. 3 is an enlarged front view of the front suspension system of FIG. 1;

FIG. 4 is an enlarged front view of the front suspension system of FIG. 1, shown in a turning posture;

FIG. 5 is an enlarged plan view of the front suspension system of FIG. 1, shown in a turning posture;

FIG. 6 is a top perspective view of a front suspension system in accordance with another embodiment of the present disclosure;

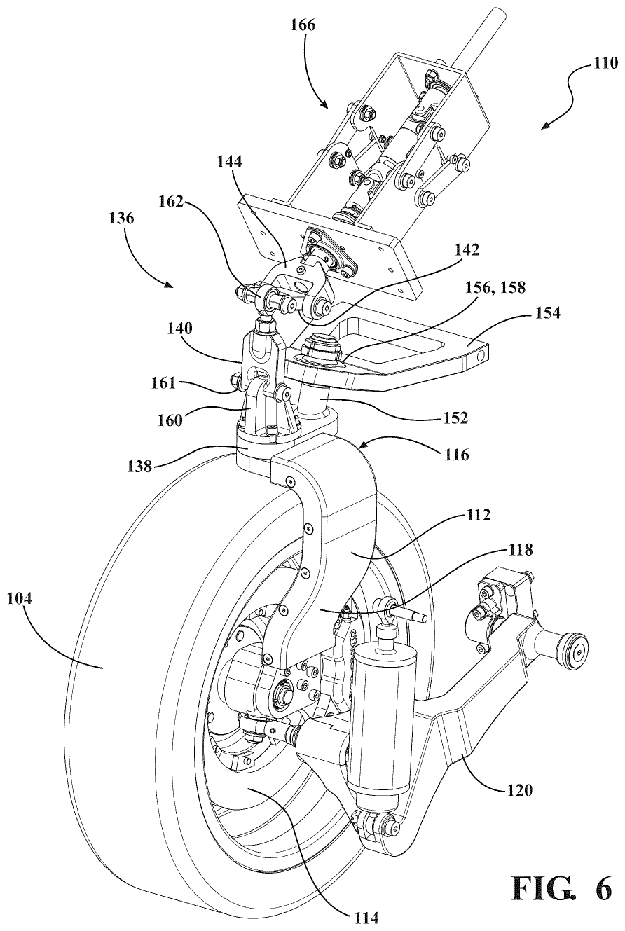

FIG. 7 is a side elevational view of the front suspension system of FIG. 6;

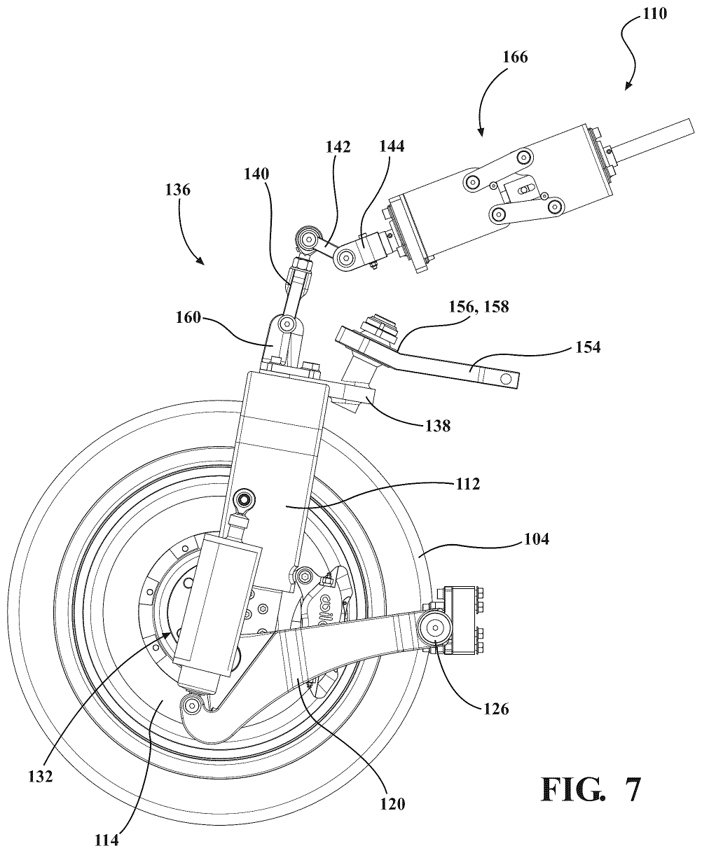

FIG. 8 is a front elevational view thereof; and

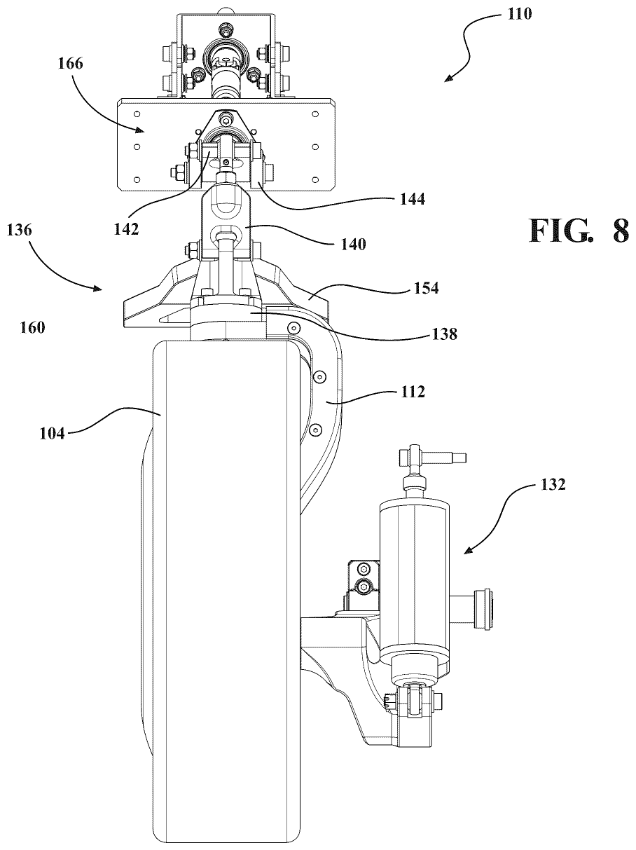

FIG. 9 is a top plan view thereof.

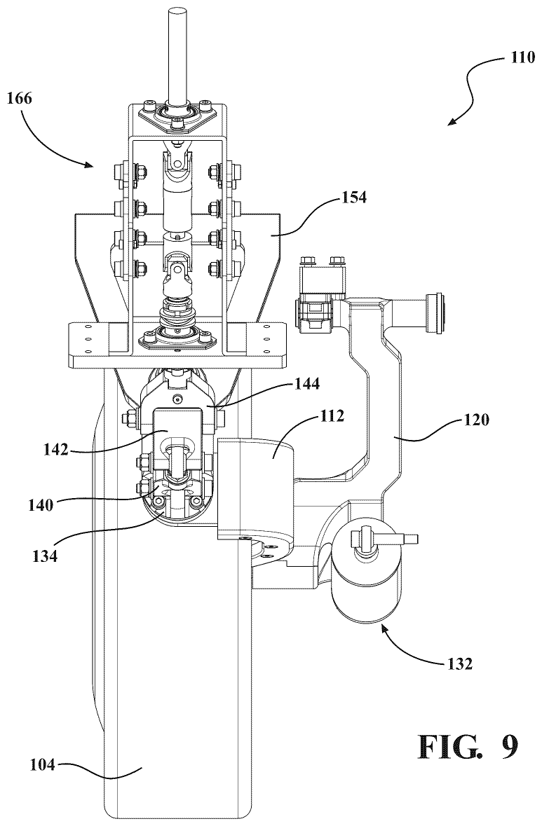

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIGS. is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The present technology improves the turning capabilities and handling characteristics of three-wheeled vehicles by introducing a front suspension system and method for turning. This approach addresses the handling deficiencies associated with conventional leaning techniques used in traditional three-wheeled vehicles. In particular, the technology enhances the turning performance by leaning only the front wheel while maintaining the frame, power plant, and rear wheel(s) in an upright posture. Notably, the front suspension system leans the front wheel in the opposite direction of the body roll during turning maneuvers.

By utilizing a configuration of components, including lower and upper control arms, a steering knuckle, steering linkage, and a steering arm, the present technology allows for precise control over the orientation of the front wheel during turns. The suspension system enables the adjustment of camber gain based on the available body roll, improving the tire-ground contact area and, consequently, the overall handling behavior of the vehicle. The present technology improves upon existing three-wheeled vehicle designs by offering a more sophisticated and effective approach to managing the unique dynamics of these vehicles during turns, without compromising performance. It should be appreciated that camber angle refers to the angle between the vertical axis of a wheel and the vertical axis of the vehicle when viewed from the front or rear.

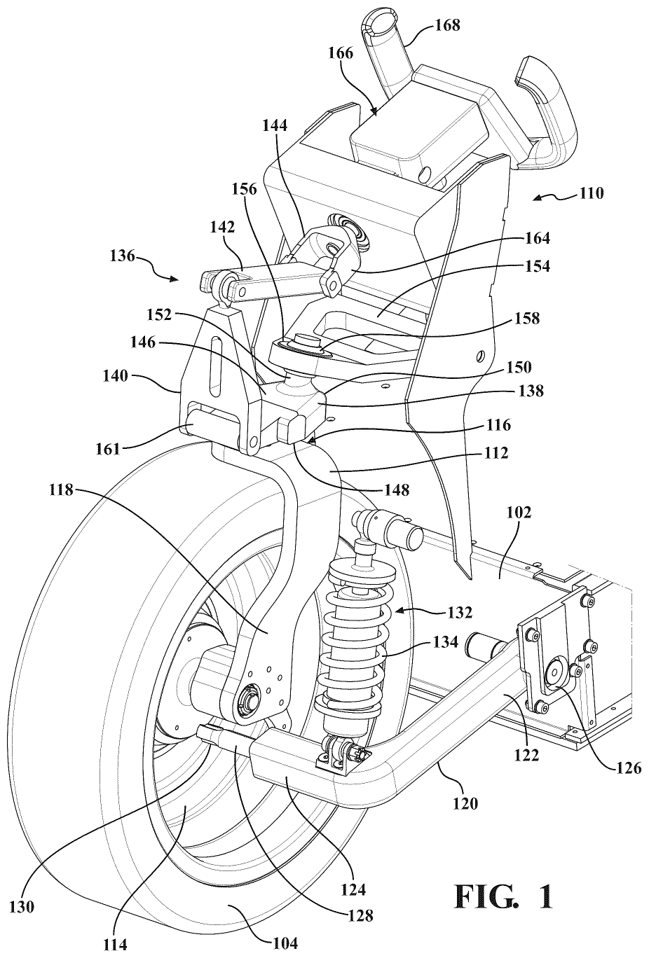

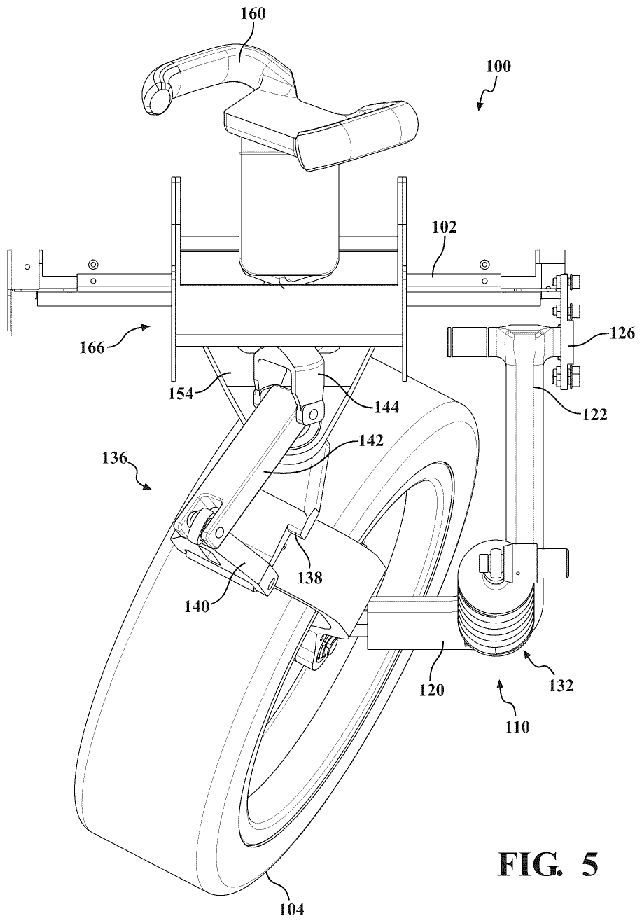

With reference to FIGS. 1-5, a three-wheeled vehicle 100 is shown. The three-wheeled vehicle 100 can include a frame 102. Attached to the frame can be a front wheel 104 and opposing rear wheels 106. Each of the front wheel 104 and the opposing rear wheels 106 of the three-wheeled vehicle 100 can be attached to and rotate around axles or bearings that are part of the structure of the frame 102. This arrangement can allow each of the front wheel 104 and the opposing rear wheels 106 to spin freely while being securely connected to the frame 102 of the three-wheeled vehicle 100. While the embodiment of the three-wheeled vehicle 100 shown in FIGS. 1-5 illustrates a lone front wheel 104 and opposing rear wheels 106, it is further known in the art that the three-wheeled vehicle 100 can have opposing front wheels and a lone rear wheel.

The frame 102 can further support an engine, gas tank, and other ancillary systems for the three-wheel vehicle. While the three-wheeled vehicle 100 shown throughout is described above as being powered by an engine, it is contemplated that in other embodiments, the three-wheeled vehicle 100 can be powered by other power plants, including the non-limiting example of an electric motor and batteries.

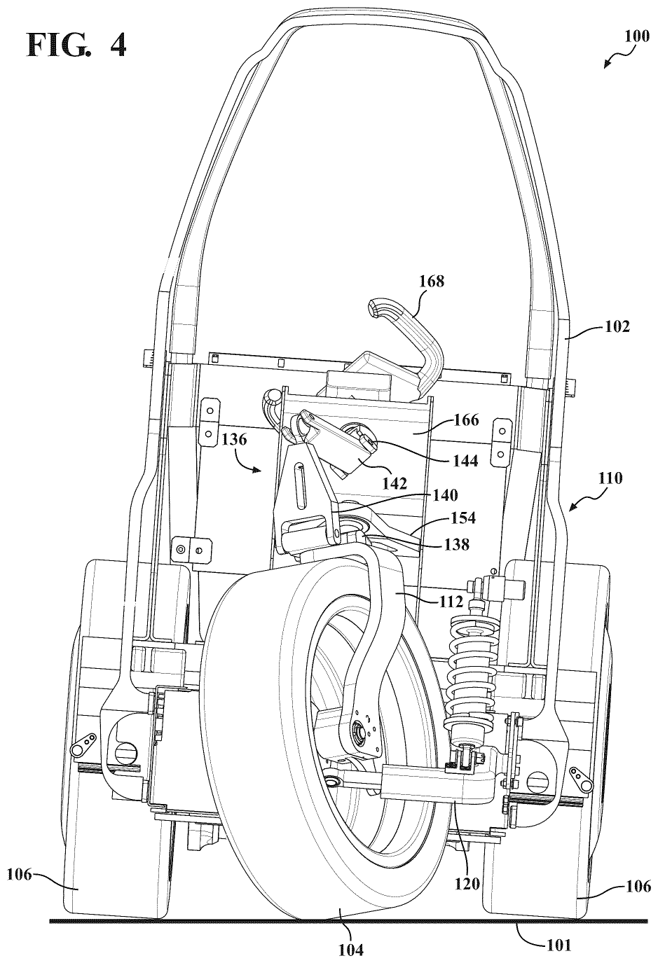

Referring again to FIGS. 1-5, a front suspension system 110 of the three-wheeled vehicle 100 is shown. The front suspension system 110 of the three-wheeled vehicle 100 can enable the three-wheeled vehicle 100 to transition between an upright posture and a turning posture. The upright posture, for example as shown in FIGS. 1-3, describes the normal, non-turning configuration of the three-wheeled vehicle 100. In the upright posture, a vertical axis of the vehicle forms a substantially perpendicular angle (approximately 90 degrees) with a level surface 101. All components of the vehicle, including the frame 102, the front wheel 104, and the rear wheels 106 can be aligned vertically. This upright posture serves as the baseline configuration from which the three-wheeled vehicle 100 transitions into the turning posture when executing a turn. The turning posture, for example as shown in FIG. 4, refers to the configuration of the three-wheeled vehicle 100 during a turning maneuver. The turning posture can be characterized by an arrangement where only the front wheel 106 leans in the direction of the turn. When entering a turn, the front suspension system 110 can allow only the front wheel 104 to lean in the direction of the turn, while maintaining the frame 102, power plant, and rear wheels 106 in an upright position. This configuration defines the turning posture, where the front wheel 106 leans in the opposite direction of the body roll of the three-wheeled vehicle 100 where “body roll” is understood to mean the axial rotation of the frame 102 of the three-wheeled vehicle 100 towards an outside of a turn.

Referring again to FIGS. 1-5, the front suspension system 110 can include a steering knuckle 112. The steering knuckle 112 can be disposed on a wheel hub 114 of the front wheel 104. The steering knuckle 112 can therefore connect the wheel 104 to the suspension system 110. Movement of the steering knuckle 112 can directly translate to movement of the front wheel 104, as described in greater detail herein.

The steering knuckle 112 can be hook-shaped. The hook shape of the steering knuckle 112 can include a top portion 116 that extends upward and over the front wheel 104, while a lower portion 118 can be disposed substantially parallel to the front wheel 104. It should be appreciated that the lower portion 118 can extend along only one side of the front wheel 104. Advantageously, the hook-shaped of the steering knuckle 112 can allow for optimal positioning of the steering components and provide clearance for the wheel 104 during turning maneuvers. During turning maneuvers, the steering knuckle 112 can stay substantially in line with the front wheel 104.

The lower portion 118 of the steering knuckle 112 can be disposed on the wheel hub 114. The lower portion 118 of the wheel hub 114 can be connected using suitable fasteners or co-formed, offering flexibility in the manufacturing and assembly process. Various types of fasteners can be employed, such as bolts, nuts, screws, or pins, depending on the specific requirements of the connection. Alternatively, co-formation can involve creating the components as a single, integrated unit during the manufacturing process, potentially enhancing structural integrity and reducing the number of separate parts. A skilled artisan can select a suitable connection for the lower portion 118 and the wheel hub 114 within the scope of the present disclosure.

The steering knuckle 112 can be attached to the frame 102 via the lower control arm 120. The lower control arm 120 can be disposed on only the side of the front wheel 104 with the lower portion 118 of the steering knuckle 112. The single-sided arrangement can contributes to the ability of the front suspension system 110 to allow the front wheel 104 to “lean” during turning maneuvers while keeping the rest of the frame 102 of the three-wheeled vehicle 100 upright. During turning maneuvers, the lower control arm 120 can be configured to stay substantially in line with the frame 102, the lower control arm 120 can helps aid in controlled and predictable movement of the front wheel 104 during turns.

The lower control arm 120 can be generally L-shaped. The L-shaped configuration of the lower control arm 120 can allow for efficient force distribution and contributes to the overall stability of the suspension system 110. The lower control arm 120 can include a first end 122 and a second end 124. The first end 122 of the lower control arm 120 can be disposed on the frame 102. The first end 122 of the lower control arm 120 can be connected to the frame 102 using pivot joints or bushings 126. The bushings 126 can allow the lower control arm 120 to pivot up and down, enabling the suspension system 110 to absorb bumps and maintain tire contact with the road while also militating against lateral movement of the lower control arm 120. The bushings 126 can also help to isolate vibrations and reduce noise transmission from the road to the frame 102.

The second end 124 of the lower control arm 120 can be disposed on the wheel hub 114 or the steering knuckle 112 of the front suspension system 110. In some embodiments, a connection element 128 can be provided between the lower control arm 120 and the steering knuckle 112. The connection element 128 can be configured to be laterally movable to compensate for the lean of the front wheel 104 during turning maneuvers. The connection element 128 can include a bearing or joint 130 to facilitate the required movement between the lower control arm 120 and the steering knuckle 112. The bearing or joint 130 can be, for example, a ball joint, spherical bearing, or another type of flexible connection that permits lateral movement while maintaining structural integrity. The inclusion of such a movable connection element 128 can allow the steering knuckle 112 and wheel 104 to adjust position relative to the lower control arm 120 as the suspension geometry changes during turning and leaning.

The lower control arm 120 can also be in communication with the dampening system 132 of the front suspension system 110. A dampening element 134 can be disposed between the lower control arm 120 and the frame 102. The dampening element 134 can include a shock absorber or a spring, as non-limiting examples. The dampening system 132 can be connected to each of the lower control arm 120 and the frame 102 via bushings 126 or pivot joints, which allow for vertical movement of the dampening system 132, in operation. A skilled artisan can select suitable placements and dampening elements 134, within the scope of the present disclosure.

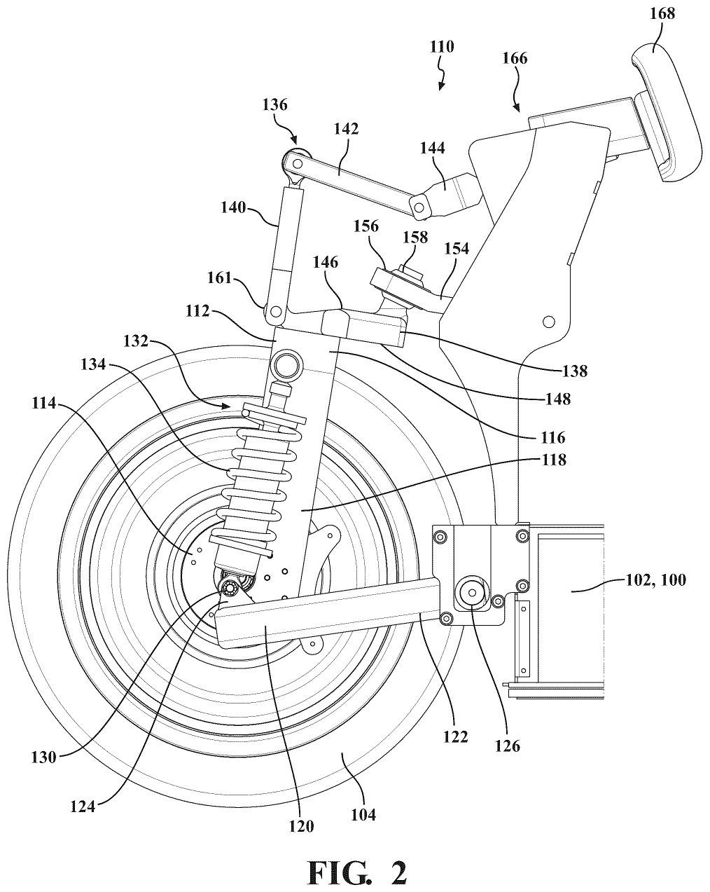

With renewed reference to FIGS. 1-2, the top portion 116 of the steering knuckle 112 can be connected to a steering linkage 136. In general, the steering linkage 136 can be configured to receive an input from a user (e.g., the user steering the three-wheeled vehicle 100) and translate the input into a rotation of the steering knuckle 112 which then results in the three-wheeled vehicle 100 performing a turning maneuver. In other words, the steering linkage 136 can translate the driver's steering inputs to the actual movement of the front wheel. The steering linkage 136 can include a steering arm 138, a lower steering link 140, an upper steering link 142, and a steering fork 144.

The steering arm 138 can have a top side 146 and a bottom side 148. The steering arm 138 can be affixed to the steering knuckle 112 in a manner that ensures a fixed relationship between these components. When the steering arm 138 is moved via the mechanical action of the steering linkage 136, the steering linkage 136 can directly transfer this movement to the steering knuckle 112 without any change in their relative geometry. As such, similar to steering knuckle 112, the steering arm 138 can remain aligned with the front wheel 104 in the turning posture. In particular, the bottom side 148 of the steering arm 138 can be affixed to the steering knuckle 112.

At a distal end 150 of the steering arm 138, a projection 152 can extend from the top side 146 of the steering arm 138. The projection 152 of the steering arm 138 can be received by an upper control arm 154. The upper control arm 154 can be A-shaped configuration, which can provide stability and support to the front wheel 104. The A-shape can allow for optimal distribution of forces and contribute to the overall structural integrity of the suspension system 110. The upper control arm 154 can be connected to the frame 102 of the vehicle 100 at a proximal end and to the steering arm 138 at the distal end. In particular, the upper control arm 154 can include an aperture 156 formed therethrough that receives the projection 152 of the steering arm 138. The upper control arm 154 can be connected to the frame 102 of the vehicle 100 at a proximal end and to the steering arm 138 at the distal end. To accommodate the rotation of the projection 152 of the steering arm 138 within the aperture of the upper control arm, a bearing 158 or similar component can be incorporated. The bearing 158 can serve to compensate for the movement of the steering linkage 136 relative to the fixed position of the upper control arm 154 in the turning posture.

The steering arm 138 can include an extension 160. The extension 160 can be affixed to the steering arm 138 using various non-limiting examples of fasteners, such as bolts, nuts, screws, or pins. Alternatively, the steering arm 138 and the extension 160 can be co-formed creating a single, integrated unit. In the upright posture, the extension 160 can extend from and be substantially perpendicular to the steering arm 138.

The lower steering link 140 can be hingedly attached to the extension 160 of the steering arm 138 via a hinge 161. The hinged connection can facilitate the necessary movement and articulation between the lower steering link 140 and the extension 160 during steering and suspension operations. In the turning posture, the angle between the lower steering link 140 and the steering arm 138 can change based on the degree of the turn. The rotation of the lower steering link 140 relative to the steering arm 138 can allow for the steering linkage 136 to compensate for movement of other components of the steering linkage 136. Similarly to the steering arm 138, the lower steering link 140 can be configured to stay in line with the front wheel 104 in the turning posture. In additional embodiments, the lower steering link 140 can be hingedly connected to the steering arm 138 via the hinge 161.

The upper link 142 can be connected to the lower link 140. In particular, the upper link 142 can be attached to the lower steering link 140 at an end opposite the extension 160. The connection between the lower steering link 140 and the upper link 142 can include a bearing 162 that allows for multiaxial rotation of the upper link 142. The bearing 162 forming the connection between the upper link 142 and lower link 140 can incorporate a ball joint bearing or spherical bearing, which can accommodate rotation around multiple axes, providing the necessary freedom of movement for the complex motions involved in the steering and suspension system 110. The ball joint bearing 162 can include of a spherical inner surface that can rotate within a matching outer socket, allowing for rotation in multiple directions while maintaining a secure connection between the upper link 142 and lower link 140. Advantageously, the bearing 162 can be particularly suitable for the front suspension system 110, as the bearing 162 can facilitate the required articulation and adjustment of the steering mechanism during various driving conditions.

At the other end of the upper link 142 opposite the bearing 162, the upper link 142 can be connected to the steering fork 144. The steering fork 144 can be generally C-shaped. At an open end 164 of the steering fork 144, the steering fork 144 can receive the upper link 142. In particular, the end of the upper link 142 can be disposed entirely in the open end 164 of the steering fork 144. The connection between the upper link 142 and the steering fork 144 can be facilitated through a hinged joint at the open end 164 of the C-shaped steering fork. The hinged connection can allow for rotational movement between the upper link 142 and the steering fork 144, which can facilitate the articulation of the steering mechanism. The hinge can incorporate suitable bearings or bushings to ensure smooth rotation and reduce friction between the components, similar to other hinged connections in the suspension system.

The front suspension system 110 can include a steering column 166. The steering column 166 can be in communication with the steering fork 144. In certain embodiments, the steering column 166 can be directly connected to the steering fork 144. The steering column 166 for the front suspension system 110 can be configured to connect a steering wheel 168 to the steering linkage 136, facilitating the transfer of driver inputs to the front wheel 104. The steering column 166 can include several components to ensure smooth and responsive steering operation. The components can include a steering shaft, which can directly connect the steering wheel 168 to the steering linkage 136. The steering shaft can be configured with universal joints to allow for flexibility and accommodate the movement of the suspension system 110 during operation. The steering column can incorporate a collapsible section, which can help absorb impact energy during a collision. Additionally, the steering column can house various controls mounted on or near it, such as turn signals, windshield wiper controls, and potentially a cruise control system, providing easy access for the driver. The steering column can also include a steering lock mechanism for security purposes. This feature can help prevent unauthorized use of the vehicle when it is parked. The function of the steering column 166 in the front suspension system 110 can be to translate the rotational movement of the steering wheel 168 into the appropriate movement of the steering linkage 136. The rotation of the steering fork 144 can be determined by the rotation of the steering wheel 168.

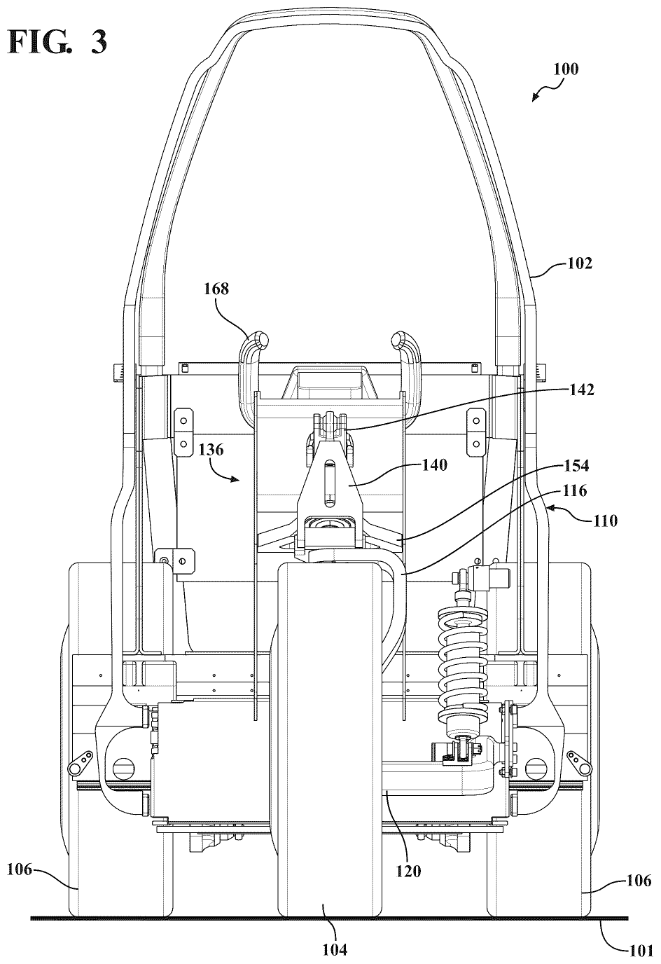

The transition from the upright posture shown in FIG. 3 to the turning posture of the three-wheeled vehicle 100, shown in FIG. 4, can be initiated when the user turns the steering wheel 168, which can set in motion a complex chain of events that ultimately allows the front wheel 104 to turn and lean, while maintaining the frame 102 and rear wheels 106 in a generally upright position. As the user rotates the steering wheel 168, the rotational movement can be transmitted through the steering column 166.

The steering column 166 can effectively translate the circular motion of the steering wheel 168 into the linear motion needed to actuate the steering linkage 136. The steering input can then be transferred to the steering fork 144, which can be generally C-shaped and connected to the upper steering link 142 via a hinged joint at the open end 164. The rotation of the steering fork 144 can cause the upper steering link 142 to move. This movement can be facilitated by the hinged connection between the upper steering link 142 and the steering fork 144, which can incorporate suitable bearings or bushings to ensure smooth rotation and reduce friction. The movement of the upper steering link 142 can then be transferred to the lower steering link 140 through the bearing 162 that connects them. The bearing 162 can be a ball joint bearing or spherical bearing. The lower steering link 140, which can be hingedly attached to the extension 160 of the steering arm 138, can move in response to the movement of the upper link 142, which can cause the steering arm 138 to rotate.

The steering arm 138 can be generally A-shaped, with the bottom side 148 affixed to the steering knuckle 112. The rotation of the steering arm 138 can be transferred to the steering knuckle 112, which can be directly connected to the wheel hub 114 of the front wheel 104. As the steering knuckle 112 rotates, the steering knuckle 112 can cause the front wheel 104 to turn. Simultaneously, the suspension system 110, including the lower control arm 120 and upper control arm 154, can work to maintain the contact of the front wheel 104 with the road surface and induce the desired “leaning” effect. During this process, the front wheel 104 can lean in the opposite direction of the body roll, while the frame 102, power plant, and rear wheels 106 can remain in an upright position.

Throughout this turning process, several components can maintain specific alignments. The lower control arm 120 and the upper control arm 154 can be configured to stay substantially in line with the frame 102 in the turning posture. Conversely, the steering knuckle 112, lower steering link 140, and steering arm 138 can be configured to stay substantially in line with the front wheel 104 in the turning posture. This arrangement can contribute to the ability of the suspension system 110 to induce a camber change in the front wheel, leaning it in the opposite direction of the body roll during turns.

The dampening system 132, which can include a dampening element 134 such as a shock absorber or spring, can work in conjunction with the lower control arm 120 to absorb bumps and maintain tire contact with the road. This can help ensure smooth operation and stability during the turning maneuver.

Though shown and described herein with reference to a three-wheeled vehicle 100 having only one front wheel 104, it should be appreciated that the front suspension system 110 of the present disclosure can be utilized in three-wheeled vehicles with two front wheels and a single rear wheel, known as a tadpole configuration. In a tadpole three-wheeled vehicle, the front suspension system 110 can be duplicated for each of the two front wheels. The principle of leaning the front wheels in the opposite direction of the body roll during turns would still apply. However, instead of a single front wheel leaning, both front wheels would lean simultaneously and in coordination. The suspension system 110 can be configured to allow both front wheels to lean independently, yet in a synchronized manner, which can be achieved through a modified steering linkage system that connects both front wheel assemblies. The steering input from the driver can then be distributed evenly to both front wheels, ensuring they turn and lean in unison.

The front suspension system 110 of the three-wheeled vehicle 100 can allow for the adjustment of camber gain based on the available roll of the vehicle body. This adjustment can be achieved by modifying the initial caster angle and a total length of the steering linkage 136, which can affect how the steering knuckle 112 and front wheel 104 respond to steering inputs. The dampening element 134 of the dampening system 132 can ensure that these movements remain smooth and controlled, even over uneven surfaces.

The counter-leaning action of the front wheel 104 can serve to maintain optimal tire contact with the road surface throughout the turn. As the three-wheeled vehicle 100 enters a turn and experiences body roll, the suspension system 110 can activate, causing the front wheel 104 to lean in the opposite direction. This action can enhance traction and control during the turning maneuver. When the vehicle 100 exits the turn, the system can return to its neutral position, with the front wheel 104 realigning vertically relative to the road surface. By actively counteracting the negative effects of body roll on front wheel camber, which typically degrades handling in delta configuration tricycles, the suspension system 110 can maintain better stability and control.

The improved contact patch and optimized camber angle can allow for better utilization of the tire's design characteristics, including factors like tread pattern, rubber compound, and sidewall stiffness, which are engineered to perform best under specific load conditions. In summary, the structure of the present technology, with its unique combination of components and adjustable parameters, can directly enable the improved handling characteristics by optimizing tire contact, adapting camber angle, counteracting body roll effects, and allowing for customized performance tuning.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A front suspension system for a three-wheeled vehicle having a frame and a front wheel, comprising:
the frame;
the front wheel having a wheel hub;
a steering knuckle disposed on the wheel hub of the front wheel;
a lower control arm having a first end disposed on the frame and a second end disposed on the wheel hub;
a steering arm affixed to the steering knuckle;
a steering linkage connected to the steering arm;
wherein the front suspension system is configured to enable the three-wheeled vehicle to transition between an upright posture and a turning posture, the turning posture characterized by the front wheel leaning in a direction of a turn.

2. The front suspension system of claim 1, wherein the steering knuckle is hook-shaped, comprising a top portion that extends upward and over the front wheel, and a lower portion disposed substantially parallel to the front wheel.

3. The front suspension system of claim 2, wherein the lower portion of the steering knuckle is disposed on the wheel hub.

4. The front suspension system of claim 1, wherein the lower control arm is generally L-shaped and disposed on only one side of the front wheel.

5. The front suspension system of claim 1, wherein the first end of the lower control arm is connected to the frame using pivot joints or bushings.

6. The front suspension system of claim 1, further comprising a connection element between the second end of the lower control arm and the steering knuckle, wherein the connection element is configured to be laterally movable.

7. The front suspension system of claim 6, wherein the connection element includes a bearing or joint to facilitate movement between the lower control arm and the steering knuckle.

8. The front suspension system of claim 1, further comprising a dampening system in communication with the lower control arm.

9. The front suspension system of claim 8, wherein the dampening system includes a dampening element disposed between the lower control arm and the frame.

10. The front suspension system of claim 1, wherein the steering linkage includes a top side and a bottom side, and the bottom side of the steering arm is affixed to the steering knuckle.

11. The front suspension system of claim 1, further comprising an upper control arm, wherein the steering arm includes a projection at a distal end that is received by the upper control arm.

12. The front suspension system of claim 11, wherein the upper control arm is A-shaped and connected to the frame at a proximal end and to the steering arm at the distal end.

13. The front suspension system of claim 1, wherein the steering linkage comprises a lower steering link and an upper steering link.

14. The front suspension system of claim 13, wherein the lower steering link includes an extension that is affixed to the steering arm.

15. The front suspension system of claim 14, wherein the lower steering link is hingedly attached to the extension of the steering arm.

16. The front suspension system of claim 14, wherein the upper steering link is connected to the lower steering link via a bearing that allows for multiaxial rotation of the upper steering link.

17. The front suspension system of claim 16, further comprising a steering fork in communication with the steering linkage.

18. The front suspension system of claim 17, wherein the steering fork is generally C-shaped and receives an end of the upper steering link at an open end of the steering fork.

19. The front suspension system of claim 1, further comprising a steering column in communication with the steering linkage.

20. A front suspension system for a three-wheeled vehicle having a frame and a front wheel, comprising:
the frame;
the front wheel having a wheel hub;
a hook-shaped steering knuckle disposed on the wheel hub of the front wheel, the steering knuckle comprising a top portion that extends upward and over the front wheel, and a lower portion disposed substantially parallel to the front wheel;
an L-shaped lower control arm having a first end disposed on the frame and a second end disposed on the wheel hub, wherein the lower control arm is disposed on only one side of the front wheel;
a connection element between the second end of the lower control arm and the steering knuckle, wherein the connection element is configured to be laterally movable and includes a bearing or joint to facilitate movement between the lower control arm and the steering knuckle;
a dampening system in communication with the lower control arm, wherein the dampening system includes a dampening element disposed between the lower control arm and the frame;
a steering arm affixed to the steering knuckle, the steering arm having a top side and a bottom side, wherein the bottom side of the steering arm is affixed to the steering knuckle;
an upper control arm connected to the frame at a proximal end, wherein the steering arm includes a projection at a distal end that is received by the upper control arm;
a steering linkage connected to the steering arm, the steering linkage including
a lower steering link including an extension that is affixed to the steering arm, wherein the lower steering link is hingedly attached to the extension of the steering arm,
an upper steering link connected to the lower steering link via a bearing that allows for multiaxial rotation of the upper link;
a C-shaped steering fork in communication with the steering linkage, wherein the steering fork receives an end of the upper link at an open end of the steering fork;
a steering column in communication with the steering linkage;
wherein the front suspension system is configured to enable the three-wheeled vehicle to transition between an upright posture and a turning posture, the turning posture characterized by the front wheel leaning in a direction of a turn while the frame remains substantially upright.
